(19) United States
(12) Patent Application Publication
(10) Pub. No.: US 2014/0189431 A1
(43) Pub. Date: Jul. 3, 2014

(54) METHOD AND SYSTEM FOR MONITORING TRANSACTION EXECUTION ON A COMPUTER NETWORK AND COMPUTER STORAGE MEDIUM

(71) Applicant: Tencent Technology (Shenzhen) Company Limited, Shenzhen city (CN)

(72) Inventors: Wei LUO, Shenzhen city (CN); Chaojiang ZHAN, Shenzhen city (CN); Shuai YANG, Shenzhen city (CN); Yao ZHAO, Shenzhen city (CN)

(73) Assignee: Tencent Technology (Shenzhen) Company Limited, Shenzhen city (CN)

(21) Appl. No.: 14/197,667

(22) Filed: Mar. 5, 2014

Related U.S. Application Data
(63) Continuation of application No. PCT/CN2013/072852, filed on Mar. 19, 2013.

(30) Foreign Application Priority Data
Apr. 17, 2012 (CN) 201210112854.X

(51) Int. Cl. G06F 11/30

(52) U.S. Cl. CPC G06F 11/3006
USPC 714/37

(57) ABSTRACT

A method and system for monitoring transaction execution on a computer network, and a computer storage medium are provided. The method for monitoring transaction execution on a computer network in accordance with an embodiment of the disclosure, including the steps of: acquiring monitoring data of a transaction executing on a computer network, and abstracting abnormal data from the monitoring data; acquiring an abnormal service based on the abnormal data; and locating a source of execution failure of the transaction in architecture layers of the transaction constructed on the computer network based on the abnormal service.

### CROSS REFERENCE TO RELATED APPLICATIONS

This application is a continuation application of PCT Application PCT/CN2013/072852 filed on Mar. 19, 2013 claiming a priority from Chinese Application No. 201210112854.X filed on Apr. 17, 2012. The aforementioned patent applications are hereby incorporated by reference in their entirety.

### FIELD OF THE INVENTION

The disclosure relates to the field of computer network, particularly to a method and system for monitoring transaction execution on computer network and computer storage medium.

### BACKGROUND

Various transactions, for example, a third party application on an open platform, a virtual network community, a video broadcasting website, etc, are executed in networks such as the Internet, a local area network, a wide area network, etc. Generally, a transaction provides services to a user dependent on its execution environments, the execution environments including various elements for providing logic processing and data storage for the transaction. During the execution process of the transaction, it is necessary to pay attention to failures appearing in the execution environments of the transaction and timely analyze and process the failures.

A traditional method for monitoring transaction execution on a computer network monitors each kind of execution environments of the transaction in real time, the execution environments including network environments, devices such as a server and so on, transaction components, and transaction software etc. If an abnormality is monitored in an execution environment of the transaction, alarms will be issued in the form of short messages or e-mails, and a person maintaining the transaction can learn of the execution environment in which a failure occurs by viewing contents of the alarms.

However, various kinds of execution environments of the transaction are interdependent. For example, the normal execution of the transaction software depends on the normal execution of the transaction components, and the normal execution of the transaction software and the transaction components depends on the normal execution of execution environments such as the network environments and the server, etc. Therefore, when a failure is monitored in an execution environment of the transaction during the execution process of the transaction, it is usual to issue a large number of alarms to the person maintaining the transaction, which causes the person maintaining the transaction unable to accurately locate the failure based on the contents of the alarms.

### SUMMARY OF THE INVENTION

In view of the above one or more problems, a method and system for monitoring transaction execution on a computer network, and a computer storage medium are provided.

A method for monitoring transaction execution on a computer network in accordance with an embodiment of the disclosure, comprising the steps of: acquiring monitoring data of a transaction executing on a computer network, and abstracting abnormal data from the monitoring data; acquiring an abnormal service based on the abnormal data; and locating a source of execution failure of the transaction in architecture layers of the transaction constructed on the computer network based on the abnormal service.

A system for monitoring transaction execution on a computer network in accordance with an embodiment of the disclosure, comprising: a data monitoring module configured for acquiring monitoring data of a transaction executing on a computer network, and abstracting abnormal data from the monitoring data; an abnormal service acquiring module configured for acquiring an abnormal service based on the abnormal data; and a detecting module configured for locating a source of execution failure of the transaction in architecture layers of the transaction constructed on the computer network based on the abnormal service.

A computer storage medium for storing computer executable instructions, wherein the computer executable instructions are operable for: acquiring monitoring data of a transaction executing on a computer network, and abstracting abnormal data from the monitoring data; acquiring an abnormal service based on the abnormal data; and locating a source of execution failure of the transaction in architecture layers of the transaction constructed on the computer network based on the abnormal service.

With the method and system for monitoring transaction execution on a computer network and the computer storage medium in accordance with an embodiment of the disclosure, the person maintaining the transaction can accurately learn the source of execution failure of the transaction without analyzing the contents of a large number of alarms one by one.

### DESCRIPTION OF THE DRAWINGS

FIG. 1 is a flow diagram of a method for monitoring transaction execution on a computer network in accordance with an embodiment of the disclosure;

FIG. 2 is a diagram of an architecture hierarchy of the transaction in accordance with an embodiment of the disclosure;

FIG. 3 is a flow diagram of the processing of locating the source of execution failure of the transaction in the architecture layers of the transaction constructed on the computer network based on the abnormal service in accordance with an embodiment of the disclosure;

FIG. 4 is a flow diagram of the processing of processing the recorded abnormal points in the sequence of the architecture layers in the architecture hierarchy of the transaction to locate the source of execution failure of the transaction in accordance with an embodiment of the disclosure;

FIG. 5 is a structure diagram of a system for monitoring transaction execution on a computer network in accordance with an embodiment of the disclosure;

FIG. 6 is a structure diagram of the detecting module in accordance with an embodiment of the disclosure;

FIG. 7 is a structure diagram of the detecting module in accordance with another embodiment of the disclosure.

### DETAILED DESCRIPTION

FIG. 1 illustrates a flow diagram of a method for monitoring transaction execution on a computer network in accordance with an embodiment of the disclosure. As shown in FIG. 1, the method for monitoring transaction execution on a computer network in accordance with an embodiment of the disclosure comprises the following steps:

Step S10: acquiring monitoring data of a transaction executing on a computer network and abstracting abnormal data from the monitoring data.

In the embodiment, the monitoring data of the transaction is acquired by monitoring the execution process of the transaction executing on the computer network, wherein the monitoring data is configured for explicitly indicating whether the execution of the transaction is normal. For example, the monitoring data can be the number of online users, the number of complaints by users, the delay induced when a user accesses a web page, and so on. The monitoring data comprises normal data produced by the normal execution of the transaction on the computer network and abnormal data produced by the abnormal execution of the transaction on the computer network (i.e., a failure occurs in the execution of the transaction). For example, the abnormal data can be data indicating that a web page is inapplicable.

Step S30: acquiring an abnormal service based on the abnormal data.

In the embodiment, in the execution process of the transaction, multiple functions are provided for a user via various services. For example, in the execution process of a transaction, various functions provided by multiple services form a processing capability owned by the transaction. The abnormal service (i.e., the service in which a failure occurs) is acquired based on the abstracted abnormal data, and the source inducing the abnormal service is found by subsequent processing.

S50: locating the source of execution failure of the transaction in architecture layers of the transaction constructed on the computer network based on the abnormal service.

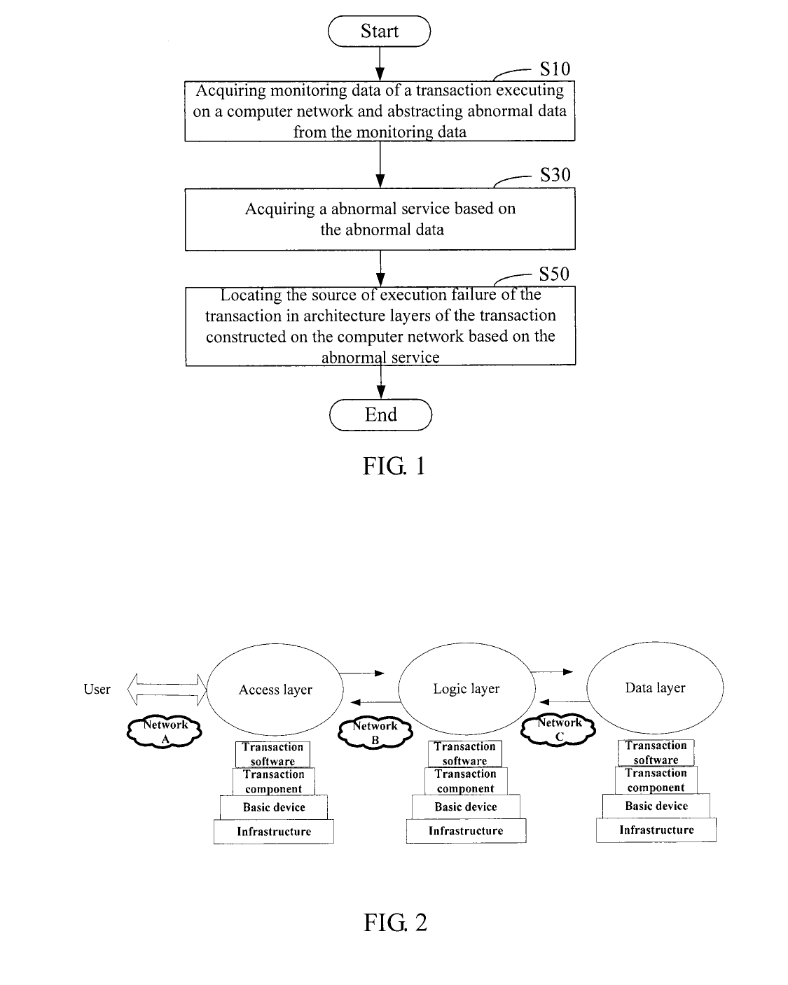

FIG. 2 illustrates a diagram of an architecture hierarchy of the transaction in accordance with an embodiment of the disclosure. As shown in FIG. 2, the architecture hierarchy of the transaction in accordance with an embodiment of the disclosure is a layered model comprising an access layer, a logic layer, and a data layer in sequence from a front end to a back end. Wherein, the access layer is configured for receiving requests from a user and forwarding the requests from the user to the logic layer; the logic layer is configured for providing a page displaying an interface for the user, responding to the requests from the user forwarded by the access layer to implement logic processing, and returning the processing result to the access layer; and the data layer is configured for temporarily or persistently storing various data necessary for and/or produced by the logic processing. The transaction executes in the architecture hierarchy of the transaction in response to various requests from the user.

As shown in FIG. 2, each of the access layer, the logic layer, and the data layer comprises elements such as transaction software, transaction components, basic networks, basic devices and infrastructures etc. Wherein, the transaction components are public domain software packets or software architecture packets (for example, WebServer components, network communicating components, database components, etc.); the transaction software executes on the transaction components, and most of the transaction software are programs directly provided for the user's access (for example, Common Gateway Interface (CGI) providing a page displaying an interface for a user); the basic devices are devices such as servers, switches, routers, etc.; and the infrastructures are data center, electrical supply equipments, data center space, etc.

Furthermore, the architecture hierarchy of the transaction can also comprise a transaction software layer, a transaction component layer, a basic device layer, and an infrastructure layer in sequence from the front end to the back end, and will not be divided into the access layer, the logic layer, and the data layer.

In the embodiment, in addition to detecting whether an abnormality exists in the architecture layer in which the abnormal service exists, multiple architecture layers related with the abnormal service should also be detected for abnormality in order to locate the source of execution failure, and obtain the failure source inducing an abnormality in the service.

In the above method for monitoring transaction execution, the processing of acquiring a corresponding abnormal service based on the abnormal data in the monitoring data and locating the source of execution failure of the transaction in related architecture layers based on the abnormal service is not simply taking the abnormal service as the source of execution failure in the execution of the transaction, but to correspondingly detect the architecture layers related with the abnormal service to locate the source of execution failure, which improves the monitoring accuracy, and further facilitates the maintenance of the transaction executing on the computer network.

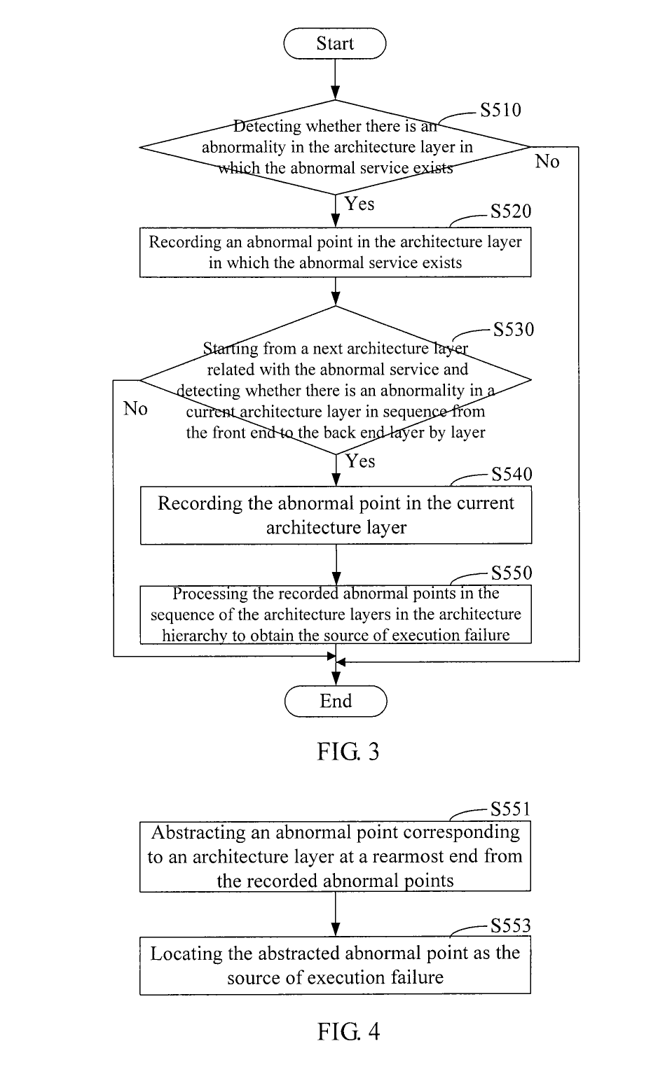

FIG. 3 illustrates a flow diagram of the processing of locating the source of execution failure of the transaction in the architecture layers of the transaction constructed on the computer network based on the abnormal service in accordance with an embodiment of the disclosure. As shown in FIG. 3, in an embodiment, the specific processing of the above step S50 comprises:

Step S510: detecting whether an abnormality exists in the architecture layer in which the abnormal service exists; if so, proceeding to step S520; or else, ending the processing of step S50.

In the embodiment, it is to detect whether respective segments in the architecture layer in which the abnormal service exists are abnormal, and record the abnormal points appearing in the architecture layer. Different architecture layers and different elements in an architecture layer correspond to different abnormal points. Specifically, an abnormal point is a description of an abnormal phenomenon, which is configured for determining whether an architecture layer and elements in thereof are abnormal. For example, for a basic device in an architecture layer, the abnormal point is that a server cannot be connected; and for a basic network in an architecture layer, the abnormal point is that the packet loss rate of the network is larger than 30%.

Step S520, recording the abnormal point in the architecture layer in which the abnormal service exists.

Step S530, starting from a next architecture layer related with the abnormal service and detecting whether there is an abnormality in a current architecture layer in sequence from the front end to the back end in the architecture hierarchy of the transaction layer by layer; if so, then proceeding to step S40, or else, ending the processing of step S50.

In the architecture hierarchy of the transaction, a service in an architecture layer at the front end is usually dependent on a service(s) in a next architecture layer at the back end immediately following the front end to implement a corresponding function. Herein, the architecture layer at the back end is called the next architecture layer of the architecture layer at the front end, and the service in the architecture layer at the back end is called a downstream service of the service in the architecture layer at the front end. In the embodiment, it is necessary to detect layer by layer whether there is an abnormal point in a current architecture layer starting from the next architecture layer of the architecture layer in which the abnormal service exists. Specifically, it is detected whether there is a downstream service in the current architecture layer in sequence from the front end to the back end in the architecture hierarchy of the transaction. If so, then it is further determined whether there is an abnormal point in the downstream service. It there is an abnormal point in the downstream service, the abnormal point is recorded.

In another embodiment, the above step S50 further comprises: determining whether there is a next architecture layer related with the abnormal service; if so, then proceeding to step S530; or else, taking the abnormal point recorded if it is detected that there is an abnormality in the architecture layer in which the abnormal service exists as the source of execution failure of the transaction.

That is to say, when it is determined that an abnormal service normally operates independent of services in a next architecture layer, an abnormal point in the architecture layer in which the abnormal service exists is the source of execution failure of the transaction, and it is unnecessary to detect layer by layer, so the efficiency of failure detecting is improved. Specifically, it can be determined whether there is a next architecture layer related with the abnormal service by determining whether there is a service related with the abnormal service (i.e. a downstream service) in the next architecture layer.

Step S540, recording the abnormal point in the current architecture layer.

Step S550, processing the recorded abnormal points in sequence from the front end to the back end in the architecture hierarchy of the transaction to locate the source of execution failure of the transaction.

In the embodiment, multiple recorded abnormal points are collected, and are processed in sequence from the front end to the back end in the architecture hierarchy of the transaction to locate the source of execution failure of the transaction. In the execution process of the transaction, an abnormal point appearing in any architecture layer may lead to the abnormal service. So collecting all abnormal points can determine the most possible failure cause and implement correlation analysis of respective architecture layers. Specifically, several recorded abnormal points are analyzed in association in the sequence of the architecture layers in the architecture hierarchy of the transaction to obtain the source of execution failure of the transaction.

In the above method for monitoring transaction execution, the most possible failure cause is determined by collecting all abnormal points to implement correlation analysis of respective architecture layers. That is, relatively discrete abnormal points are considered, so an accurate failure cause is obtained.

In an embodiment, the specific processing of the above step S550 comprises: abstracting an abnormal point corresponding to a maximum priority as the source of execution failure of the transaction from the recorded abnormal points based on priorities corresponding to the architecture layers.

In the embodiment, a priority can be preset for each architecture layer, the priority being configured for identifying the possibility of an abnormal point inducing an abnormal service in an architecture layer. That is to say, the priority also represents an influence factor inducing an abnormal service. An abnormal point having a maximum priority is an abnormal point having a maximum influence factor inducing an abnormal service, the possibility of becoming the source of execution failure of which is the maximum. Therefore, the abnormal point having the maximum priority can be abstracted from the recorded abnormal points based on priorities corresponding to the architecture layers, and the source of execution failure of the transaction can be located based on the abstracted abnormal point.

As to multiple abnormal points having the maximum priority, it is further determined which one of the multiple abnormal points is the source of execution failure of the transaction based on priorities of elements in an architecture layer. For example, if a failure occurs in an infrastructure, the failure must influence the basic devices, the basic components and the basic software. Therefore, if there is an abnormal point in both an infrastructure and a basic device, the abnormal point in the infrastructure is preferably considered as the source of execution failure of the transaction, etc.

FIG. 4 illustrates a flow diagram of the processing of processing the recorded abnormal points in the sequence of the architecture layers in the architecture hierarchy of the transaction to locate the source of execution failure of the transaction in accordance with an embodiment of the disclosure. As shown in FIG. 4, in another embodiment, the specific processing of the above step S550 comprises:

Step S551, abstracting an abnormal point corresponding to an architecture layer at a rearmost end in the architecture hierarchy of the transaction from the recorded abnormal points.

In the embodiment, the abnormal point corresponding to the architecture layer at the rearmost end is abstracted from the recorded abnormal points based on the sequence from the front end to the back end in the architecture hierarchy of the transaction, and the abnormal point in the architecture layer at the rearmost end is taken as the source inducing the abnormal service.

Step S553, taking the abstracted abnormal point as the source of execution failure of the transaction.

In an embodiment, the above method for monitoring transaction execution further comprises presenting the source of execution failure and its corresponding abnormal point in a failure locating page to facilitate viewing by the person maintaining the transaction.

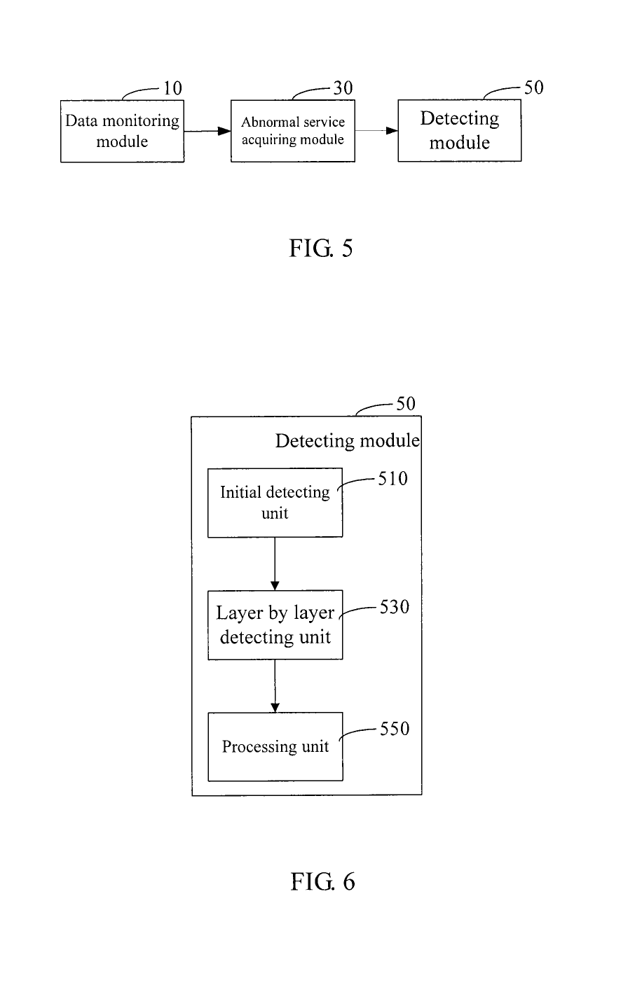

FIG. 5 is a structure diagram of a system for monitoring transaction execution on a computer network in accordance with an embodiment of the disclosure. As shown in FIG. 5, in an embodiment, the system for monitoring transaction execution on a computer network comprises a data monitoring module 10, an abnormal service acquiring module 30, and a detecting module 50. Wherein:

The data monitoring module 10 is configured for acquiring monitoring data of a transaction executing on a computer network and abstracting abnormal data from the monitoring data.

In the embodiment, the monitoring data of the transaction is acquired by monitoring the execution process of the transaction executing on the computer network, wherein the monitoring data is configured for explicitly indicating whether the execution of the transaction is normal. For example, the monitoring data can be the number of online users, the number of complaints by users, the delay induced when a user accesses a web page, and so on. The monitoring data comprises normal data produced by the normal execution of the transaction on the computer network and abnormal data produced by the abnormal execution of the transaction on the computer network (i.e., a failure occurs in the execution of the transaction). For example, the abnormal data can be data indicating that a web page is inapplicable.

The abnormal service acquiring module 30 is configured for acquiring an abnormal service based on the abnormal data.

In the embodiment, in the execution process of the transaction, multiple functions are provided for a user via various services. For example, in the execution process of a transaction, various functions provided by multiple services form a processing capability owned by the transaction. The abnormal service acquiring module 30 acquires the abnormal service based on the abstracted abnormal data, and the source inducing the abnormal service is found out by subsequent processing.

The detecting module 50 is configured for locating the source of execution failure of the transaction in architecture layers of the transaction constructed on the computer network based on the abnormal service.

In the embodiment, the architecture hierarchy of the transaction is a layered model comprising an access layer, a logic layer, and a data layer in sequence from the front end to the back end. Wherein the access layer is configured for receiving requests from a user and forwarding the requests from the user to the logic layer; the logic layer is configured for providing a page displaying an interface for the user, responding to the requests from the user forwarded by the access layer to implement logic processing, and returning the processing result to the access layer; and the data layer is configured for temporarily or persistently storing various data necessary for and/or produced by the logic processing. The transaction executes in the architecture hierarchy of the transaction constructed on the computer network in response to various requests from the user.

Each of the access layer, the logic layer, and the data layer comprises elements such as transaction software, transaction components, basic networks, basic devices and Infrastructures etc. Wherein, the transaction components are public domain software packets or software architecture packets; the transaction software executes on the transaction components, and most of the transaction software are programs directly provided for the user for accessing; the basic devices are devices such as servers, switches, routers and so on; and the infrastructures are data center, electrical supply equipments, data center space and so on.

Furthermore, the architecture hierarchy of the transaction can also comprise a transaction software layer, a transaction component layer, a basic device layer and an infrastructure layer in sequence from the front end to the back end, and is not divided into the access layer, the logic layer and the data layer any longer.

In the embodiment, in addition to detecting whether an abnormality exists in the architecture layer in which the abnormal service exists, the detecting module 50 further detects multiple architecture layers related with the abnormal service for abnormality in order to locate the source of execution failure, and obtain the failure source inducing an abnormality in the service.

In the above system for monitoring transaction execution, the processing of acquiring a corresponding abnormal service based on the abnormal data in the monitoring data and locating the source of execution failure of the transaction in related architecture layers based on the abnormal service is not simply to take the abnormal service as the source of execution failure in the execution of the transaction, but to correspondingly detect the architecture layers related with the abnormal service to locate the source of execution failure, which improves the monitoring accuracy, and further facilitates the maintenance of the transaction executing on the computer network is further facilitated.

FIG. 6 is a structure diagram of the detecting module in accordance with an embodiment of the disclosure. As shown in FIG. 6, the above detecting module 50 comprises an initial detecting unit 510, a layer by layer detecting unit 530, and a processing unit 550.

The initial detecting unit 510 is configured for detecting whether an abnormality exists in the architecture layer, in which the abnormal service exists; if so, then recording the abnormal point in the architecture layer in which the abnormal point exists; or else, stopping execution.

In the embodiment, the initial detecting unit 510 detects whether respective segments in the architecture layer in which the abnormal service exists are abnormal, and records abnormal points appearing in the architecture layer. Different architecture layers and different elements in an architecture layer correspond to different abnormal points. Specifically, an abnormal point is a description of an abnormal phenomenon, which is configured for determining whether an architecture layer and elements in the architecture layer are abnormal.

The layer by layer detecting unit 530 is configured for starting from a next architecture layer related with the abnormal service and detecting whether there is an abnormality in a current architecture layer in sequence from the front end to the back end in the architecture hierarchy of the transaction layer by layer; if so, then recording the abnormal point in the current architecture layer.

In the architecture hierarchy of the transaction, a service in an architecture layer at the front end is usually dependent on a service(s) in a next architecture layer at the back end immediately following the front end to implement a corresponding function. Herein, the architecture layer at the back end is called the next architecture layer of the architecture layer at the front end, and the service in the architecture layer at the back end is called a downstream service of the service in the architecture layer at the front end. In the embodiment, it is necessary for the layer by layer detecting unit 530 to detect layer by layer whether there is an abnormal point in a current architecture layer starting from the next architecture layer of the architecture layer in which the abnormal service exists. Specifically, the layer by layer detecting unit 530 detects whether there is a downstream service in the current architecture layer in sequence from the front end to the back end in the architecture hierarchy of the transaction. If so, then it is further determined whether there is an abnormal point in the downstream service. It there is an abnormal point in the downstream service, the abnormal point is recorded.

The processing unit 550 is configured for processing the recorded abnormal points in sequence from the front end to the back end in the architecture hierarchy of the transaction to locate the source of execution failure of the transaction.

In the embodiment, the processing unit 550 collects multiple recorded abnormal points, and processes them in sequence from the front end to the back end in the architecture hierarchy of the transaction to locate the source of execution failure of the transaction. In the execution process of the transaction, an abnormal point appearing in any architecture layer may lead to the abnormal service. So collecting all abnormal points can determine the most possible failure cause and implement correlation analysis of respective architecture layers. Specifically, the processing unit 550 analyzes several recorded abnormal points in association in the sequence of the architecture layers in the architecture hierarchy to obtain the source of execution failure of the transaction.

In the above system for monitoring transaction execution, the most possible failure cause is determined by collecting all abnormal points together to implement correlation analysis of respective architecture layers. That is, relatively discrete abnormal points are considered, so an accurate failure cause is obtained.

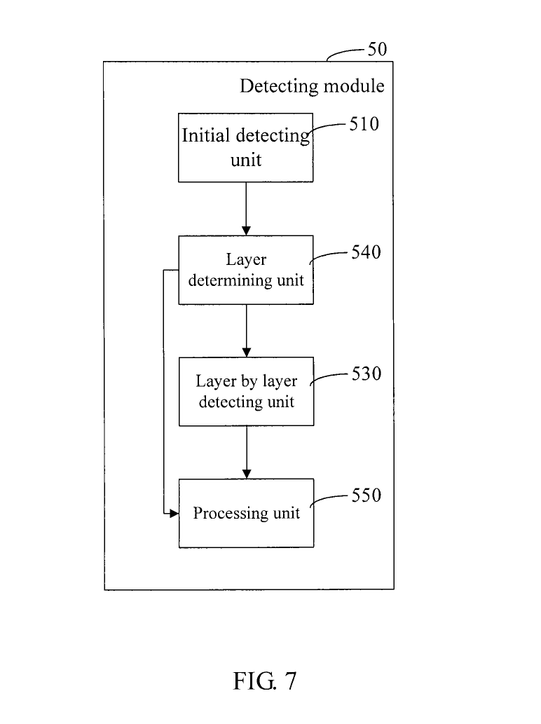

FIG. 7 is a structure diagram of the detecting module in accordance with another embodiment of the disclosure. As shown in FIG. 7, the above detecting module 50 further comprises a layer determining unit 540 for determining whether there is a next architecture layer related with the abnormal service, and if so, informing the layer by layer detecting unit 530, or else informing the processing unit 550.

In the embodiment, when the layer determining unit 540 determines that an abnormal service normally operates independent of a service(s) in a next architecture layer, an abnormal point in the architecture layer in which the abnormal service exists is the source of execution failure of the transaction, and it is unnecessary to detect layer by layer, so the efficiency of failure detecting is improved. Specifically, the layer determining unit 540 determines whether there is a next architecture layer related with the abnormal service by determining whether there is a service related with the abnormal service (i.e. a downstream service) in the next architecture layer.

The above processing unit 550 is further configured for locating the recorded abnormal point as the source of execution failure.

In an embodiment, the above processing unit 550 is further configured for abstracting an abnormal point corresponding to a maximum priority as the source of execution failure from the recorded abnormal points in accordance with priorities corresponding to the architecture layers.

In the embodiment, a priority can be preset for each architecture layer, the priority being configured for identifying the possibility of an abnormal point inducing an abnormal service in an architecture layer. That is to say, the priority also represents an influence factor inducing an abnormal service. An abnormal point having a maximum priority is an abnormal point having a maximum influence factor causing a service abnormal, the possibility of becoming the source of execution failure of which is the maximum. Therefore, the processing unit 550 can abstract the abnormal point having the maximum priority from the recorded abnormal points based on priorities corresponding to the architecture layers, and thus locate the failure source based on the abstracted abnormal point.

As to multiple abnormal points having the maximum priority, the processing unit 550 further determines which one of the multiple abnormal points is the source of execution failure of the transaction based on priorities of elements in an architecture layer. For example, if a failure occurs in an infrastructure, the failure must influence the basic devices, the basic components and the basic software. Therefore, if there is an abnormal point in both an infrastructure and a basic device, the abnormal point in the infrastructure is preferably considered as the source of execution failure of the transaction, and so on.

In another embodiment, the above processing unit 550 is further configured for abstracting an abnormal point corresponding to the architecture layer at the rearmost end from the recorded abnormal points, and taking the abstracted abnormal point as the source of execution failure of the transaction.

In the embodiment, the processing unit 550 abstracts the abnormal point corresponding to the architecture layer at the rearmost end from the recorded abnormal points in sequence from the front end to the back end in the architecture hierarchy of the transaction, and takes the abnormal point in the architecture layer at the rearmost back end as the source causing the service abnormal.

In an embodiment, the above system for monitoring transaction execution further comprises presenting the source of execution failure and its corresponding abnormal point in a failure locating page to facilitate viewing by the person maintaining the transaction.

In the above described method and system for monitoring transaction execution, architecture layers associated with the abnormal service are detected in sequence from the front end to the back end in the architecture hierarchy of the transaction to learn whether a failure occurring in each architecture layer is a primary factor for causing the abnormal service. So the execution failure can be accurately located in the multiple architecture layers, and it is unnecessary for the person maintaining the transaction to analyze the contents of a large number of alarms one by one.

The disclosure further provides a computer storage medium storing computer executable instructions, wherein the computer executable instructions are operable for controlling a computer to implement the above method for monitoring transaction execution, specific steps of which are described above and thus are omitted herein.

The above embodiments are merely several implementations of the disclosure, the descriptions of which are specific and in detail and cannot be considered as limiting the scope of the disclosure. It should be pointed out that the person skilled in the art can make some alterations and improvements to the disclosure without departing from the concept of the disclosure. The protection scopes of the disclosure are merely limited by the claims.

1-18. (canceled)

19. A method for monitoring transaction execution on a computer network, comprising the steps of:
acquiring monitoring data of a transaction executing on a computer network, and abstracting abnormal data from the monitoring data;
acquiring an abnormal service based on the abnormal data; and
locating a source of execution failure of the transaction in architecture layers of the transaction constructed on the computer network based on the abnormal service.

20. The method for monitoring transaction execution of claim 19, wherein the processing of locating the source of execution failure of the transaction in the architecture layers of the transaction constructed on the computer network based on the abnormal service comprises:
detecting whether there is an abnormality in an architecture layer in which the abnormal service exists, if so, then recording an abnormal point in the architecture layer in which the abnormal service exists;
starting from a next architecture layer associated with the abnormal service and detecting whether there is an abnormality in a current architecture layer in sequence from a front end to a back end in an architecture hierarchy of the transaction layer by layer, if so, then recording an abnormal point in the current architecture layer;
processing the recorded abnormal points in sequence from the front end to the back end in the architecture hierarchy of the transaction to locate the source of execution failure of the transaction.

21. The method for monitoring transaction execution of claim 20, wherein the processing of locating the source of execution failure of the transaction in the architecture layers of the transaction based on the abnormal service further comprises:
determining whether there is a next architecture layer associated with the abnormal service, if so, then performing the processing of starting from the next architecture layer associated with the abnormal service and detecting in sequence from the front end to the back end in the architecture hierarchy of the transaction layer by layer;
or else, taking the abnormal point recorded if it is detected that there is an abnormality in the architecture layer in which the abnormal service exists as the source of execution failure of the transaction.

22. The method for monitoring transaction execution of claim 20, wherein the processing of processing the recorded abnormal points in sequence from the front end to the back end in the architecture hierarchy of the transaction to locate the source of execution failure of the transaction comprises:
abstracting an abnormal point corresponding to a maximum priority as the source of execution failure of the transaction from the recorded abnormal points based on priorities corresponding to the architecture layers of the transaction.

23. The method for monitoring transaction execution of claim 20, wherein the processing of processing the recorded abnormal points in sequence from the front end to the back end in the architecture hierarchy of the transaction to locate the source of execution failure of the transaction comprises:
abstracting an abnormal point corresponding to an architecture layer at a rearmost end in the architecture hierarchy of the transaction from the recorded abnormal points;
taking the abstracted abnormal point as the source of execution failure of the transaction.

24. The method for monitoring transaction execution of claim 23, wherein, after the processing of processing the recorded abnormal points in sequence from the front end to the back end in the architecture hierarchy of the transaction to locate the source of execution failure of the transaction, the method further comprises:
presenting the source of execution failure of the transaction and the abnormal point in a failure locating page.

25. A system for monitoring transaction execution on a computer network, comprising:
a data monitoring module configured for acquiring monitoring data of a transaction executing on a computer network, and abstracting abnormal data from the monitoring data;
an abnormal service acquiring module configured for acquiring an abnormal service based on the abnormal data; and
a detecting module configured for locating a source of execution failure of the transaction in architecture layers of the transaction constructed on the computer network based on the abnormal service.

26. The system for monitoring transaction execution of claim 25, wherein the detecting module comprises:
an initial detecting unit configured for detecting whether there is an abnormality in an architecture layer in which the abnormal service exists, if so, then recording an abnormal point in the architecture layer in which the abnormal service exists;
a layer by layer detecting unit configured for starting from a next architecture layer associated with the abnormal service and detecting whether there is an abnormality in a current architecture layer in sequence from a front end to a back end in an architecture hierarchy of the transaction layer by layer, if so, then recording an abnormal point in the current architecture layer;
a processing unit configured for processing the recorded abnormal points in sequence from the front end to the back end in the architecture hierarchy of the transaction to locate the source of execution failure of the transaction.

27. The system for monitoring transaction execution of claim 26, wherein the processing module further comprises:
a layer determining unit configured for determining whether there is a next architecture layer associated with the abnormal service, if so, then informing the layer by layer detecting unit, or else, informing the processing unit; wherein
the processing unit is further configured for taking the abnormal point recorded if it is detected that there is an abnormality in the architecture layer in which the abnormal service exists as the source of execution failure of the transaction.

28. The system for monitoring transaction execution of claim 26, wherein the processing unit is further configured for abstracting an abnormal point corresponding to a maximum priority as the source of execution failure of the transaction from the recorded abnormal points based on priorities corresponding to the architecture layers of the transaction.

29. The system for monitoring transaction execution of claim 26, wherein the processing unit is further configured for abstracting an abnormal point corresponding to an architecture layer at a rearmost end in the architecture hierarchy of the transaction from the recorded abnormal points, and taking the abstracted abnormal point as the source of execution failure of the transaction.

30. The system for monitoring transaction execution of claim 29, wherein the system also presents the source of execution failure of the transaction and the abnormal point in a failure locating page.

31. A non-transitory computer readable storage medium for storing computer executable instructions, wherein the computer executable instructions are operable for:
acquiring monitoring data of a transaction executing on a computer network, and abstracting abnormal data from the monitoring data;
acquiring an abnormal service based on the abnormal data; and
locating a source of execution failure of the transaction in architecture layers of the transaction constructed on the computer network based on the abnormal service.

32. The computer readable storage medium of claim 31, wherein the processing of locating the source of execution failure of the transaction in the architecture layers of the transaction constructed on the computer network based on the abnormal service comprises:
detecting whether there is an abnormality in an architecture layer in which the abnormal service exists, if so, then recording an abnormal point in the architecture layer in which the abnormal service exists;
starting from a next architecture layer associated with the abnormal service and detecting whether there is an abnormality in a current architecture layer in sequence from a front end to a back end in an architecture hierarchy of the transaction layer by layer, if so, then recording an abnormal point in the current architecture layer;
processing the recorded abnormal points in sequence from the front end to the back end in the architecture hierarchy of the transaction to locate the source of execution failure of the transaction.

33. The computer readable storage medium of claim 32, wherein the processing of locating the source of execution failure of the transaction in the architecture layers of the transaction based on the abnormal service further comprises:
determining whether there is a next architecture layer associated with the abnormal service, if so, then performing the processing of starting from the next architecture layer associated with the abnormal service and detecting in sequence from the front end to the back end in the architecture hierarchy of the transaction layer by layer;
or else, taking the abnormal point recorded if it is detected that there is an abnormality in the architecture layer in which the abnormal service exists as the source of execution failure of the transaction.

34. The computer readable storage medium of claim 32, wherein the processing of processing the recorded abnormal points in sequence from the front end to the back end in the architecture hierarchy of the transaction to locate the source of execution failure of the transaction further comprises:
abstracting an abnormal point corresponding to a maximum priority as the source of execution failure of the transaction from the recorded abnormal points based on priorities corresponding to the architecture layers of the transaction.

35. The computer readable storage medium of claim 32, wherein the processing of processing the recorded abnormal points in sequence from the front end to the back end in the architecture hierarchy of the transaction to locate the source of execution failure of the transaction comprises:
abstracting an abnormal point corresponding to an architecture layer at a rearmost end in the architecture hierarchy of the transaction from the recorded abnormal points;
taking the abstracted abnormal point as the source of execution failure of the transaction.

36. The computer readable storage medium of claim 35, wherein after the processing of processing the recorded abnormal points in sequence from the front end to the back end in the architecture hierarchy of the transaction to locate the source of execution failure of the transaction, the computer executable instructions are further operable for:
presenting the source of execution failure of the transaction and the abnormal point in a failure locating page.
